(19) United States
(12) Patent Application Publication
(10) Pub. No.: US 2006/0251421 A1
(43) Pub. Date: Nov. 9, 2006

(54) IMPROVED FREE SPACE OPTICAL BUS

(75) Inventor: Shlomi Arnon, Lehavim (IL)

Correspondence Address: SALTAMAR INNOVATIONS, 30 FERN LANE, SOUTH PORTLAND, ME, 04106, US

(73) Assignee: Ben Gurion University of the Negev, Research and Development Authority, Beer Sheva (IL)

(21) Appl. No.: 11/382,346

(22) Filed: May 9, 2006

Related U.S. Application Data
(60) Provisional application No. 60/678,804, filed on May 9, 2005.

(51) Int. Cl. H04J 14/00

(52) U.S. Cl. 398/73

(57) ABSTRACT

A method and apparatus for improving the transmission quality of a free space optical bus between circuitry elements in high speed computing, communication and signal processing systems. Use is made of an adaptive algorithm that learns the transmission properties of the bus, and selects or adjusts transmission paths or characteristics to provide optimum bus performance. Each transmitter on the bus transmits a signal which is generally measured by all of the receivers on the bus, and the measured signals are used to generate a matrix which maps desired transmission along information links, and cross-link interference. Transmission quality is optimized by adjusting one or more characteristics associated with transmission along the bus, including emitted power, beam divergence, wavelength, beam polarization, antenna gain and antenna polar diagram of the transmitters, and power sensitivity, gain, equalizer coefficients, field of view, polarization sensitivity, antenna gain and antenna polar diagram of the receivers. Novel bus configurations are described, including use of different wavelengths for different bus functions.

This application claims the benefit and priority of U.S. Provisional Patent Application No. 60/678,804 filed on May 9, 2005, the full disclosure of which is hereby incorporated by reference.

### FIELD OF THE INVENTION

The present invention relates to the field of optical buses for communication between electronic circuits, especially computer or network buses utilizing free space propagation.

### BACKGROUND OF THE INVENTION

A bus can be described as a subsystem that transfers data and/or power between components or circuits inside a computer, or between computers, or between network elements. In most cases, a computer bus is implemented using conductors on printed circuit boards, or PCBs. PCB's are used to mechanically support and electrically connect electronic components using conductive pathways, or traces, etched from copper sheets laminated onto a non-conductive substrate. Historically, line widths on electronic chips have constantly been reduced, as projected by Gordon Moore in 1965. The improvement in silicon manufacturing will soon give rise to chips containing one billion transistors running at many gigahertz. Over the next decade the bandwidth of interconnects inside a computer is expected to increase by an order of magnitude—from around 1 GHz to 10 GHz, thanks to developments such as the PCI Express bus. However, this rapidly improving ability to process data within a chip or computer or network element is increasingly handicapped by the failure to provide communication over the bus at a similarly scaled rate. The problem is that electrical chip I/O elements do not scale according to Moore's Law. It has been shown that for communication frequencies above 1 GHz the following effects become dominant:

a) signal loss for copper traces on circuit boards,

b) reduction in Signal-to-Noise Ratio (SNR),

c) timing errors,

d) crosstalk among the different copper traces which limits the wiring density on the circuit board,

e) power dissipation increase, and

f) Interference (EMI/RFI) to the environment.

Electrical I/O bandwidth can only be increased by one or more of increasing power, reducing range, increasing the weight and size of the bus subsystem and adding sophisticated signal processing. More recently, the bus has sometimes been implemented by means of a bundle of wires but this still has the limitations of electrical communication. The increasing performance needs can however be accommodated by means of a shift in technologies from the electrical to the optical domain. The desire for an optical chip-to-chip solution is driven by the I/O needs of future communication systems and the increasingly complex ASICs, microprocessors and digital signal processors that support system architectures. Fiber optical buses do provide increase in performance, but still have physical disadvantages.

In order to better overcome the limitations relating to electrical buses, and without the physical bulk of fiber optical links, the concept of optical wireless communication was introduced. Optical wireless communication (OWC) is a technology for transmitting information without a waveguide, so the light propagates between the transmitter and receivers through free space. The light can be steered for example by mirrors, gratings, light pipes, spatial light modulators or any other steering device. These devices could be passive or active. Active devices could steer the light in different directions according to a control code. In other applications the light could be diffused by a diffuser and the received light could propagate by other than line of sight propagation.

The ability to optically communicate wirelessly makes it easy to place the computer components (chips), the computers or network elements in either a two or three dimensional configuration. By doing so, it is possible to reduce the size and weight of the system, to communicate at a very high date rate and to distribute clock pulses by the shortest distances, due to the three dimensional configuration. In some applications the path of light can be directed to propagate through the shortest optical path length in air with its unity index of refraction, in contrast to a wave guide with an index of refraction larger than 1, and hence a lower propagation velocity. The clock can thus propagate at a faster rate, and the computer can work at higher frequency.

For electrical technology, the primary limitations to implementing high-speed interconnections are achieving high packing density, cross talk between channels, frequency-dependent loss, and high power dissipation. Current optoelectronic technologies, which are optimized for long distance telecommunication and data communication applications, do not have the necessary characteristics (power dissipation, form factor, cost, signal integrity) needed for interconnects between high-speed electronic chips. Ideally, the use of optical interconnects will enable connecting circuit blocks on different chips to have the same performance as connecting circuit blocks on the same chip, with the exception of the time-of-flight latency. An optical chip-to-chip communication scheme is thus an attractive solution to the power, density and signal isolation issues in high-throughput, compact systems.

The use of free space optical interconnections has been described in a number of patent documents, including three dimensional chip-to-chip interconnections in U.S. Pat. No. 6,967,347 for “Terahertz Interconnect System and Application” to M. Estes et al., and US Patent Application No. 2005/0224946 for “Stackable Optoelectronics Chip-to-chip Interconnects and Method of Manufacturing” to A. K Dutta, and two dimensional inter chip communication in U.S. Pat. No. 6,661,943 for “Fiber Free Optical Interconnect System for Chip-to-chip Signaling” to Yuan-Liang Li. Two dimensional intra-chip free-space optical communication is described in the above-mentioned U.S. Pat. No. 6,967,347.

However, the optical bus configurations described therein have a number of operative disadvantages. Environmental conditions and physical limitations reduce the optical bus performance, and increase the noise and interference levels. Environmental conditions could be thermal bending or turbulence due to non-uniform heating of components, vibration, jitter and impact from external and internal sources, such as cooling fans, aircraft vibration, motor vibration, non-linearity if the propagation medium is not air, scattering of light by small particulate material in the media, and straying light due to non-perfect optics. The physical limitation could be, for example, diffraction of the transmitted light, generating interference with neighbor links.

There is thus an important need for methods of improving the quality of such optical buses.

The disclosures of each of the publications mentioned in this section and in other sections of the specification, are hereby incorporated by reference, each in its entirety.

### SUMMARY OF THE INVENTION

The present invention seeks to provide new methods for improving the quality of optical free space connections in optical bus-systems between circuitry elements in high speed computing, communication and signal processing systems. The methods are applicable to any free space optical buses, whether on a nano-scale, such as in intra- or inter-chip communication requirements in computing systems, in medium scale applications between boards or computers, or on a macro-scale, such as in a cluster of supercomputers or in the potentially noisy environment of aircraft, landcraft, spacecraft or seacraft. Additionally, the methods of the present invention may generally be used on conventional optical bus systems, without amending any of the intrinsic functional operation of the computer system components, and generally only requiring the addition of electronic or optical processing functions or modules to the bus system.

According to various preferred embodiments of the present invention, the improvement of the optical bus transmission quality is achieved by implementing an adaptive algorithm that “learns” the transmission properties of the bus, and selects or adjusts transmission paths or characteristics accordingly to provide the optimum bus performance. Different bus configurations are described, together with algorithms to allocate different wave lengths for different bus functions.

It is an object of some aspects of the present invention to provide methods and apparatus for improving communication via optical wireless links. For the purposes of the present application, the term optical wireless communication means that the optical radiation propagates in free space or in a homogenous medium but in a non-guided mode. The propagation is generally between computer components, such as chips or boards within the computer, or between computers, or between network elements. The optical wireless links may be used as some or all of the data, address, control, Input/output and any other auxiliary lines. The wavelength of the communication can range from 0.01 micro-meter to 50 micro meter. It is a further object of some aspects of the present invention to provide methods and apparatus for communicating between chip elements for on-chip communication, using optical wireless communication. For the purposes of the present application, the term chip is generally understood to mean a substrate in or on which is embedded an electronic and/or optical and/or mechanical integrated circuit.

Each chip or on-chip subsystem may preferably include an array of at least one optical transmitter and optical receiver. The transmitter may preferably include electronic functions, light sources, and optical elements. The electronics preferably includes coder, communication controller, error correction coder, compressor, driver, and modulator units. The light source could preferably be a non-coherent source such as light emitting diode (LED), or a coherent source such as a laser, or VCSEL. The light sources convert electrical signals to optical signal. The light sources, if there are more than one, may preferably all transmit the same wavelength or a combination of several wave lengths, or may hop between wavelengths and they may be modulated by different orthogonal or semi-orthogonal codes. By these means, one or more electrical lines could be mapped to one light source or one light transmission path. The light source directs its emission to the optics that shapes the radiation in the spatial domain according to the system requirements. The optics preferably includes one or more mirrors, lenses or diffractive elements or any combination thereof. In order to direct and distribute the light between the chips, any of mirrors, beam splitters, add and drop devices, fixed filters, tunable filters or polarizers may preferably be used. The receiver generally includes receiver optics that shapes the received radiation in the spatial domain according to requirements. The receiver optics preferably includes one or more lens, mirror or diffractive elements or any combination thereof. Following the optics, an opto-electronic converter converts the optical signal to an equivalent electronic signal. The opto-electronic converter can preferably be a PIN, APD or MSM device, but is not limited thereto. The electronic signal preferably passes through filters and amplifiers. The output current from the amplifier is integrated and passed to the decision device. The entire communication procedure is synchronized.

The geometrical positioning of the receivers and transmitters in the spatial domain could be vector or matrix. There are many combinations by which to position the transmitters and receivers. One option is to combine receivers and transmitters, creating transceivers and then the positioning of the transceivers in a one or two dimensional pack. Different geometrical positioning is available such as, but not limited to, beehive, triangular, rectangular. A second preferred option is to place all the receivers in one location and all the transmitters in another location.

There is thus provided in accordance with a preferred embodiment of the present invention, a a method of improving the transmission quality of a free-space optical bus system comprising the steps of:

(i) providing an optical bus having a plurality of transmitters and receivers connected by optical paths,

(ii) transmitting a signal onto the bus from one of the transmitters,

(iii) measuring the signal received by at least some of the receivers,

(iv) repeating the steps of transmitting and measuring for additional ones of the transmitters,

(v) utilizing the measured signals to generate a transmission quality function for the bus, and

(vi) optimizing the transmission quality function by adjusting at least one characteristic associated with transmission along at least one of the paths.

In the above described method, the at least one characteristic is preferably a characteristic either of at least one of the transmitters, or of at least one of the receivers. In the former case, the transmitter characteristic preferably comprises at least one of emitted power, beam divergence, emitted wavelength, beam polarization, antenna gain and antenna polar diagram, and in the latter case, the receiver characteristic preferably comprises at least one of power sensitivity, gain, equalizer coefficients, field of view, polarization sensitivity, antenna gain and antenna polar diagram. Additionally, the step of measuring the signal received by at least some of the receivers may preferably be performed for all of the receivers, and the step of repeating the steps of transmitting and measuring may preferably be performed for all of the transmitters.

In accordance with yet another preferred embodiment of the present invention, in the above described method the transmission quality of the bus is ascertained by measuring the transmission bit error rate along at least some of the optical paths. Furthermore, the transmission quality improvement is able to counteract the effects of at least one of mechanical and thermal environmental effects on the bus.

There is further provided in accordance with yet another preferred embodiment of the present invention, a method as described above, and wherein the transmission quality function is generated by utilizing each of the measured signals as elements in a two dimensional transmission matrix. This matrix preferably maps desired transmission between transmitters and their intended destination receivers, and transmission interference between transmitters and receivers other than the intended destination receivers. In such a case, signals relating to desired transmission between transmitters and their intended destination receivers are used as diagonal elements of the matrix, and signals relating to transmission interference between transmitters and receivers other than the intended destination receivers are used as off-diagonal elements of the transmission matrix.

Furthermore, in the above described matrix method, the transmission quality factor is optimized preferably by signal processing at least one of the transmitted signal or the received measured signal, the signal processing using elements derived from the inversion of the transmission matrix. Alternatively and preferably, the transmission quality factor is optimized by signal processing of the transmitted signal and the received measured signal, using elements derived from single value decomposition of the transmission matrix.

In accordance with still another preferred embodiment of the present invention, there is provided a matrix method as described above and further comprising the steps of:

(i) measuring the time of arrival of the transmitted signals at at least some of the receivers, and

(ii) storing the times of arrivals in a third array of the two dimensional matrix, such that the time domain equalization of the receivers can be performed.

There is further provided in accordance with still another preferred embodiment of the present invention, a free space optical bus system for transferring information, the bus system comprising:

(i) a plurality of light transmitters, each transmitting signals containing part of the information,

(ii) a plurality of receivers for receiving signals over free space from the transmitters, at least some of the received signals comprising a linear combination of the transmitted signals, and

(iii) a plurality of detection processors, one for each receiver, each receiving at least some of the received signals and applying weighting factors thereto, summing the weighted received signals and outputting the summations,

wherein the weighting factors are derived by transmitting a signal onto the bus sequentially from each of the transmitters and measuring the received signals at all of the receivers from each sequentially transmitted signal, using the measured signals to generate a transmission matrix for the plurality of transmitters and receivers, and using the elements of the transmission matrix to generate the weighting factors. In such a free space optical bus system, signals relating to desired transmission between transmitters and their intended destination receivers are preferably used as diagonal elements of the matrix, and signals relating to transmission interference between transmitters and receivers other than their intended destination receivers are preferably used as off-diagonal elements of the matrix. Additionally, the weighting factors may preferably be generated from elements obtained by calculating the inverse of the transmission matrix.

In accordance with a further preferred embodiment of the present invention, the above described free space optical bus system may preferably comprise a plurality of source and destination nodes connected by free space optical links, at least some of the links having different propagation properties, such that at least some of the links are associated with different transmission matrices, and wherein the weighting factors are adjusted according to knowledge about the link used between source and destination nodes. In such a case, a protocol may preferably be used in the system which declares the addresses to be linked, such that the weighting factors can be adjusted at any one of the destination and source of the requested link, according to the content of the protocol. Furthermore, at least one of the source and the destination nodes may preferably be preprogrammed with information about its links with at least one other node in the system.

There is also provided in accordance with yet a further preferred embodiment of the present invention, a free space optical bus system as described above and also comprising a plurality of information signal processors, each processor receiving at least part of the information, at least one of the processors comprising electronic multipliers applying a second set of weighting factors to the received information, and an electronic summer for summing the received information weighted with the second set of weighting factors, and for outputting the summed weighted information to the light transmitters. In such a situation, the weighting factors and the second set of weighting factors may preferably be generated from elements obtained by singular value decomposition performed on the transmission matrix.

There is even further provided in accordance with another preferred embodiment of the present invention a free space optical bus system for transferring information contained in a number of channels, the bus system comprising:

(i) a plurality of signal processors, each processor receiving the information in at least some of the channels, at least one of the processors comprising electronic multipliers applying predetermined weighting factors to the received information, and an electronic summer for summing the weighted received information and for outputting the summed weighted information,

(ii) a plurality of light sources receiving the outputs from the signal processors, and transmitting the outputs as optical signals onto the bus, and

(iii) a plurality of receivers for receiving optical signals from the transmitters over the free space bus, and for outputting the information,

wherein the weighting factors are derived by transmitting a signal onto the bus sequentially from each of the transmitters and measuring the received signals at all of the receivers from each sequentially transmitted signal, using the measured signals to generate a transmission matrix for the plurality of transmitters and receivers, and using the elements of the transmission matrix to generate the weighting factors. In such a free space optical bus system, signals relating to desired transmission between transmitters and their intended destination receivers are used as diagonal elements of the matrix, and signals relating to transmission interference between transmitters and receivers other than their intended destination receivers are used as off-diagonal elements of the matrix. Additionally, the weighting factors may preferably be generated from elements obtained by calculating the inverse of the transmission matrix.

In accordance with a further preferred embodiment of the present invention, the above described free space optical bus system may preferably comprise a plurality of source and destination nodes connected by free space optical links, at least some of the links having different propagation properties, such that at least some of the links are associated with different transmission matrices, and wherein the weighting factors are adjusted according to knowledge about the link used between source and destination nodes. In such a case, a protocol may preferably be used in the system which declares the addresses to be linked, such that the weighting factors can be adjusted at any one of the destination and source of the requested link, according to the content of the protocol. Furthermore, at least one of the source and the destination nodes may preferably be preprogrammed with information about its links with at least one other node in the system.

There is also provided in accordance with yet a further preferred embodiment of the present invention, a free space optical bus system as described above and also comprising a plurality of detection processors, one for each receiver, each receiving at least some of the received signals and applying a second set of weighting factors thereto, summing the received signals weighted with the second set of weighting factors, and outputting the summations. In such a situation, the weighting factors and the second set of weighting factors may preferably be generated from elements obtained by singular value decomposition performed on the transmission matrix.

There is also provided in accordance with a further preferred embodiment of the present invention, a free space optical bus system comprising a plurality of links for transferring information between a plurality of nodes, wherein at least two of the links transmit information at different wavelengths over essentially the same optical path. Each of the links may preferably have a predetermined functionality, such that different functionalities can be separated by the wavelength of an optical signal used to transmit those functionalities.

In accordance with yet another preferred embodiment of the present invention, in such a free space optical bus system each of the links may preferably have a predetermined functionality, at least one of the functionalities comprising at least two different parts, and each of the different parts is preferably transmitted using a different wavelength, such that part selection may be made by selection of transmission wavelength. In such a case, the different parts may be any one of different memory blocks and different input/output groups. Consequently, this wavelength selection enables chip select operations to be performed in the optical domain.

In any of the above wavelength dependent optical bus systems, selection of the different wavelengths is preferably performed using a dispersive optical element.

There is further provided in accordance with yet another preferred embodiment of the present invention, a free space optical bus system comprising a plurality of links for transferring information between a plurality of nodes, wherein at least two of the links transmit information having a different code over essentially the same optical path.

In accordance with still another preferred embodiment of the present invention, there is provided a free space optical bus system for transferring optical signals between transmitters and receivers located at different nodes on the bus system, the bus system comprising sets of polarization discriminating elements located at the nodes and impressing a polarization characteristic on a signal traversing them, such that a signal leaving the bus can be spatially separated from a signal transmitted onto the bus by means of the polarization characteristic. In such a bus system, the signal leaving the bus is preferably directed to a receiver by a set of polarization discriminating elements associated with the receiver. Furthermore, the sets of polarization discriminating elements preferably comprise at least one of a polarized beam splitter and a wave plate. The wave plate may preferably be a quarter wave plate, in which case the polarization characteristic is circular polarization, or the wave plate may be a half wave plate, in which case the polarization characteristic is a linear polarization, or the wave plate may be any other suitable optical thickness.

There is further provided in accordance with still another preferred embodiment of the present invention, a free space optical bus system for transferring a plurality of optical signals serving a number of functionalities between transmitters and receivers located at nodes of the system, wherein the system comprises a number of light sources less than the number of the functionalities served by the bus. The bus system may then also preferably comprise an optical modulator at at least one of the nodes, such that at least one of the optical signals is generated by modulating an optical beam with information to be transmitted down the bus. There may preferably only be a single light source.

In accordance with a further preferred embodiment of the present invention, there is also provided a free space optical bus system for transmitting optical signals between transmitters and receivers located at nodes of the system, and also comprising at least one device for spatially directing the optical signals such that the line of sight between at least one transmitter and one receiver may be adjusted to optimize transmission of the optical signals. The device for spatially directing the optical signals may preferably comprise any one of an acquisition device, a tracking device and a pointing device.

### BRIEF DESCRIPTION OF THE DRAWINGS

The present invention will be understood and appreciated more fully from the following detailed description, taken in conjunction with the drawings in which:

FIG. 1 shows an optical free space wireless bus implemented to communicate between the various chips of a computing system, using the methods of the present invention;

FIG. 2 shows an optical bus connecting various functional circuits of a computing system, wherein different functional parts of the bus are transmitted at different wavelengths;

FIG. 3 shows schematically another preferred embodiment of the use of wavelength division, in which different parts of a single functionality are coded with different wavelengths;

FIG. 4 illustrates a preferred method of increasing the transceiver efficiency by use of polarized light in the optical bus;

FIG. 5 shows an optical bus connecting various functional circuits of a computing system, using a single light source to service a number of signal transmission functions;

FIGS. 6A to 6C schematically illustrate alternative geometrical positioning of the transceivers of the present invention;

FIG. 7 is a flow chart of a learning algorithm, according to a further preferred embodiment of the present invention, whose execution enables optimization of the performance of a free space optical bus;

FIG. 8 illustrates schematically a block diagram of a system, according to a preferred embodiment of the present invention, in which the optimization procedure of FIG. 7 may be performed by analog electronics in the bus receivers;

FIG. 9 illustrates schematically a block diagram showing how weighting factors used in the embodiment of FIG. 8 are obtained during the training phase described in the algorithm of FIG. 7;

FIG. 10 illustrates schematically a block diagram of a system, according to another preferred embodiment of the present invention, similar to that shown in FIG. 8, but in which the optimization procedure is performed in the receivers digitally;

FIG. 11 illustrates schematically a block diagram of a system, according to a further preferred embodiment of the present invention, in which the bus optimization procedure is implemented in the optical domain by using an adaptive optical spatial filter; and

FIG. 12 illustrates schematically a block diagram of a system, according to another preferred embodiment of the present invention, in which the bus optimization procedure is performed electronically in the transmitters, by means of an electronic pre-coding process.

### DETAILED DESCRIPTION OF PREFERRED EMBODIMENTS

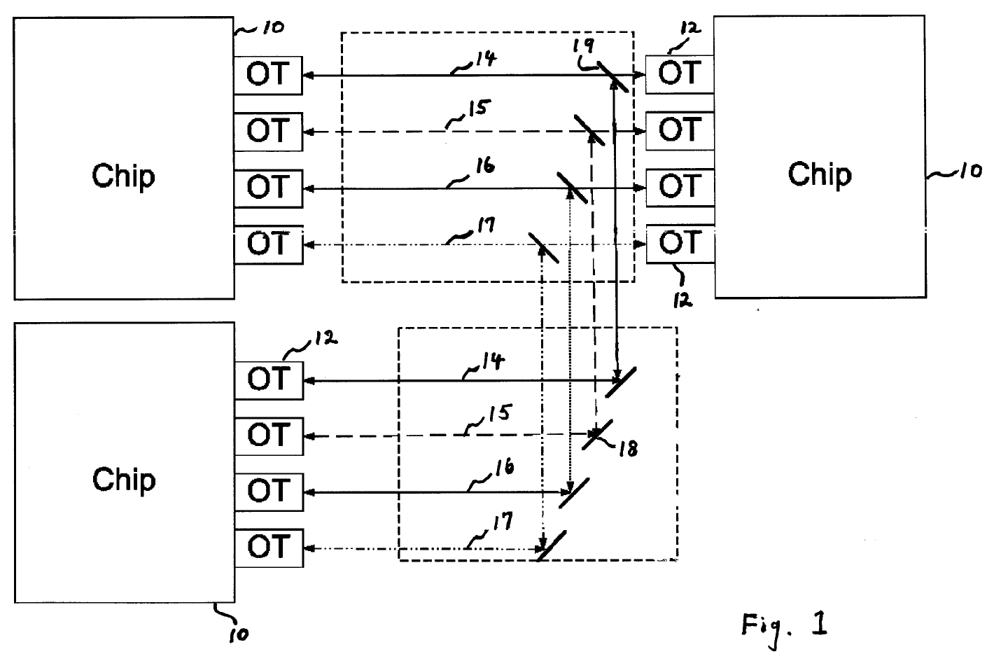

Reference is now made to FIG. 1, which illustrates schematically an optical wireless bus implemented to communicate, using the preferred methods of the present invention, between the various chips 10 of a computing system. Although only three chips are shown in FIG. 1, it is to be understood that the methods of the present invention are applicable on buses connecting any number of chips. The input/output functions of each of the chips are preferably implemented by means of optical transceivers OT, marked as items 12, though it is to be understood that separate receivers and transmitters may equally well be used. The communication lines between the various chips are implemented by means of optical transmission paths, and may be any of control lines 14, address lines 15, data lines 16 or any other auxiliary lines 17. Spatial redirection of the optical information may preferably be performed by means of arrays of mirrors 18, or, where signal splitting is required to direct the signal to two or more destinations, by means of arrays of beam splitters 19. Where more than two destination chips are required for one signal, sequential beam splitters, or three way splitters as are known in the art, may be used.

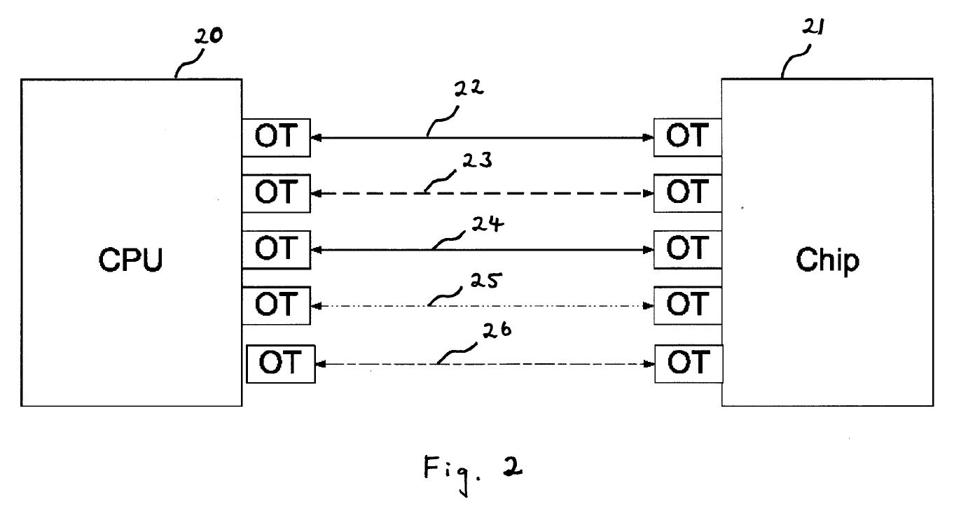

Reference is now made to FIG. 2 which illustrates schematically an optical bus, constructed and operative according to a preferred embodiment of the present invention, connecting various functional circuits of a computing system, exemplified in the embodiment of FIG. 2 by a link between the CPU 20 and a satellite chip 21. In the preferred embodiment of FIG. 2, different functional parts of the bus, such as the data 22, address 23, control 24, I/O 25 and auxiliary lines 26 are transmitted at different wavelengths. The wavelengths can preferably be generated using optical sources with different wavelengths, or broadband sources with dispersive devices such as gratings, holograms or other diffractive elements. Such dispersive devices can also preferably be used to separate and to recombine the different functionalities carried in the bus in the optical domain. The use of multiple wavelength transmission for different functionalities thus makes it possible to save space, and to differentiate simply between the different functionalities by means of such dispersive elements.

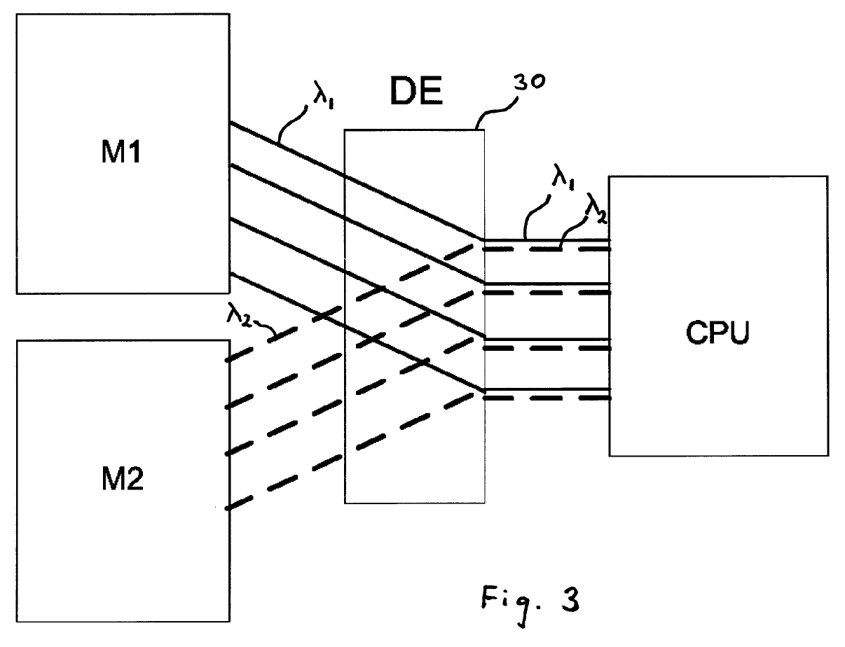

FIG. 3 shows schematically another preferred embodiment of the use of wavelength division, in which different parts of a single functionality are coded with different wavelengths. It is thus possible to divide different memory blocks or I/O groups, or any other multi-part single functionality, by using differing wavelengths, which makes it possible to perform chip select operations in the optical domain, selection of the required part being made by selection of the corresponding wavelength. In the preferred embodiment illustrated in FIG. 3, different memory blocks M1, M2 are addressed by the CPU by virtue of their different wavelengths, λ1 and λ2, and a dispersive element 30 is operative to direct each different wavelength to its correct destination, according to the “wavelength address” applied to the optical information by the CPU. Such an arrangement saves the chip select function, which would otherwise require implementation by means of an electronic chip. Furthermore, selection by means of wavelength also saves the address lines necessary for the chip select functions.

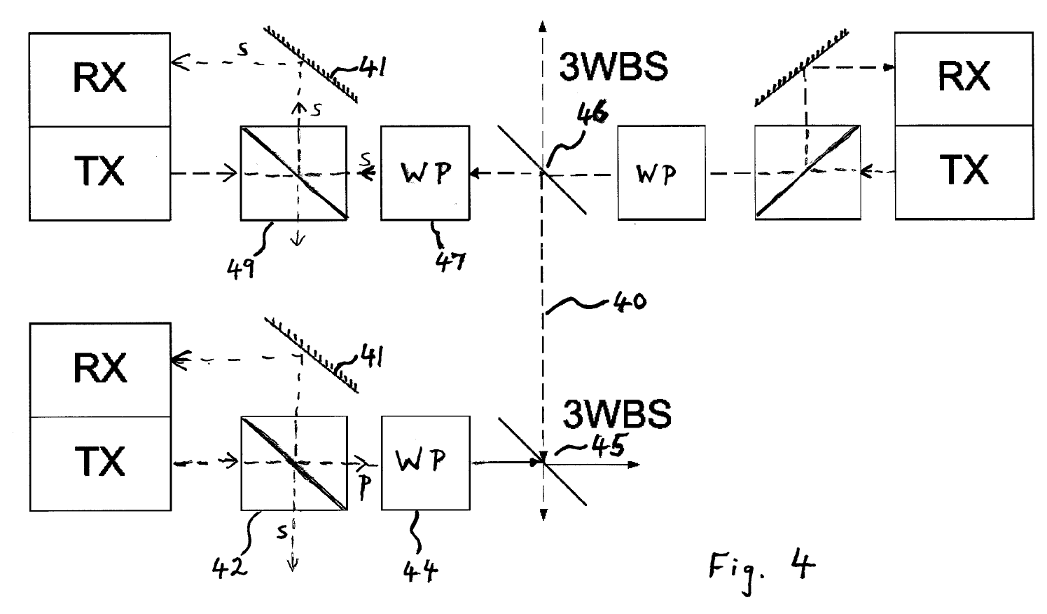

Reference is now made to FIG. 4, which illustrates a method of increasing the transceiver efficiency, according to another preferred embodiment of the present invention, using the polarization direction of the optical signals to differentiate between receivers and transmitters. FIG. 4 schematically shows an optical bus 40 connecting various functional circuits of a computing system, and wherein the transmitters and receivers at each node of the bus are in communication with transmitters and receivers at every other node in the system.

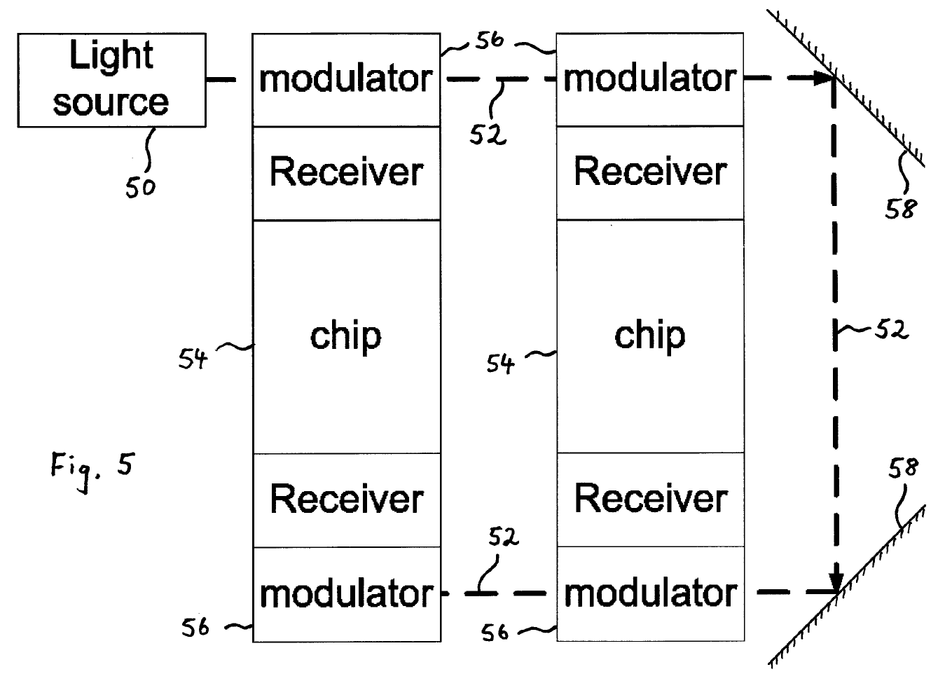

In FIG. 4, there are shown three exemplary nodes of a system, each node preferably comprising a single transmitter TX and a single receiver RX, preferably arranged as a transceiver unit. The transmitters include a source emitting light preferably having a predefined linear polarization, though this embodiment is also operable using a source having no specific polarization direction, or being unpolarized, though incurring thereby a power loss. The light can be either from a laser within the transmitter, or from an optical switching element which itself receives the light from an external laser source and transmits it after modulation from the transmitter, as described below in the preferred embodiment of FIG. 5. Each receiver RX preferably contains a detector, and any other standard electronic and optical elements needed for operation of the receiver. The receivers should preferably be polarization insensitive.

The routing of the differently polarized beam components into and out of the bus 40 is achieved using at each node a polarized beam splitter 42 and a quarter wave plate 44. The light from the transmitter propagates through the polarized beam splitter 42, which divides the input light into two orthogonally polarized beams at 90° to each other. The transmitted beam is mostly polarized parallel to the plane of incidence (p-polarized), and the reflected beam is mostly polarized perpendicular to the plane of incidence (s-polarized). The s-polarized component is reflected away, while the p-polarized component is transmitted straight through to the quarter wave plate 44. If a polarized source is preferably used, the polarization direction should be aligned to support the splitting process in the polarized beam splitter. The quarter wave plate converts the linear polarization to circular polarization. This component then enters the bus through a three-way beam splitter 45, preferably constructed from sequential beam splitting components as is known in the art. The use of a three-way beam splitter (3WBS) enables the signal to propagate in either direction down the bus. When only one direction of bus propagation is needed, then a conventional two-way beam splitter suffices. A three way beam splitter is a four-port device, generally built up from an arrangement of simpler optical components, which splits a beam entering at one port to output at the other ports. The beam can enter at any port and exit at any other port. Once on the bus, the circularly polarized light then propagates to its destination node, where it is directed off the bus by the three way beam splitter 46 of that node, or by a two-way beam splitter if sufficient, as explained above, and through another quarter wave plate 47, which applies an additional phase shift to one component of the circularly polarized light, such that it emerges essentially as linear s-polarized light. This essentially s-polarized light does not pass straight through the polarizing beam splitter 49 of that node and back into the transmitter of that node, but is reflected by the polarized beam splitter 49 to the mirror 41, which itself reflects it into the receiver at that node.

This arrangement therefore ensures separation of the light directed off the bus, which will always be directed to the receiver, from that transmitted onto the bus from the transmitter, by virtue of the specific polarization given to the propagating light on entering the bus. As an alternative to the use of quarter wave plates 44, 47, and propagation down the bus as circularly polarized light, half wave plates can be used, which rotate the polarization direction by 90 degrees, but maintain the linear polarization. In such a case, the light is propagated down the bus as linearly polarized light, but rotated relative to the linear polarization applied to the transmitted light by the polarized beam splitters. Although quarter and half wave plates are the most common polarization conversion components for use in such an embodiment, it is to be understood that this aspect of the present invention is not meant to be limited to these preferred embodiments, but can utilize any polarization conversion scheme which ensures that the beam extracted from the bus at any node is not returned in the transmitter direction, but is directed away towards the receiver by virtue of its polarization character.

Use of such a polarization separating scheme enables additional functionalities to be readily added or removed from the bus, since whatever functionality is added or removed, the correct optical path is established for added signals and for signals dropped to any and all of the other nodes, by virtue of the polarization selection techniques described according to this embodiment.

Instead of using the polarization direction of the beam component as described in FIG. 4, wavelength selection can alternatively and preferably be used in order to direct the beams to the desired receiver location. In such an embodiment, a wavelength sensitive element such as a dichroic beam splitter, and a wavelength converter are used to spatially direct the beam according to two different wavelength components instead of the polarizing beam splitter and wave plate of the embodiment of FIG. 4.

Reference is now made to FIG. 5, which is a schematic illustration of an optical bus in a computing system, according to a further preferred embodiment of the present invention, in which light sources service a number of functionalities in the bus. In a prior art conventional optical bus, each light source is used to generate a beam which performs a single function down the bus, transferring information from source to destination. According to the preferred embodiment shown in FIG. 5, a single light source can be used for all of the functions in the bus, or several light sources, but less than the total number of functions to be served, can be used to provide the functions in the bus. In FIG. 5, the light source 50, propagates down the bus 52, passing through a number of chips 54 on the way, and being modulated with the information to be transmitted down the bus by means of optical modulators 56 incorporated into the chips to be communicated with. Since this embodiment enables use of a single laser source with a higher power than in a multi-source system, the information may be extracted from the bus by directing only a small portion of the beam into each receiver, while still leaving sufficient power for detection by the other receivers on the bus. As with the previously described embodiments, bending mirrors 58 are used where necessary to direct the beam spatially along the bus path.

The use of a single or a reduced number of light sources reduces heating, energy needs and the complexity of the bus system. Each source, whether one or more, propagates through a number of chips, computers or network elements. In this case the chips, computers or network elements are optically passive in that they do not transmit energy, but operate by modulating the light propagating through them. Since a modulator is significantly less costly than a laser source, this arrangement also engenders significant cost reduction of the system, as well as reduced size and heat dissipation.

Computer systems can suffer from mechanical impact, vibration and jitter due to operation of fans, mechanical subsystem operation, and thermal bending. In some cases, the external environment can induce such mechanical interference. According to a further preferred embodiment of the present invention, an optimization procedure that minimizes the transmission bit error rate is proposed. The procedure take into consideration the statistics of the mechanical vibration, jitter and thermal bending, the communication system parameters, the interference between neighbor channels, the transmitters beam's spatial distribution and the receiver field of view. An expression for the bit error rate is calculated preferably as a function of the gain of the transmitter and/or receiver optics. The BER is also a function of the statistics of the mechanical vibration, jitter and thermal bending, so the derivative of the BER expression enables determination of the value of the transmitter and/or receiver optics gain which provide the best performance. Once the expected environment is determined, the optical characteristics of the communication links, as described below, can be set to achieve the minimum BER. Iterative or interactive change of the transmission characteristics may preferably be used to achieve the optimum transmission characteristics, such as, for instance, use of an LC element which can change output power, or change of the beam divergence, receiver gain, antenna gain, or antenna polar diagram by adjustment of suitable optical elements.

According to a further preferred embodiment of this method of the present invention, the transmitters and receivers of the computer optical bus can include acquisition, tracking and pointing devices, such as are known in the art, that make it possible to direct the transmitter beams and the receiver fields of view in order to optimally align the transmission line of sight. Use of such an embodiment enables active rerouting of the bus signals under changing transmission conditions, such that the system becomes more robust and can more easily overcome pointing errors.

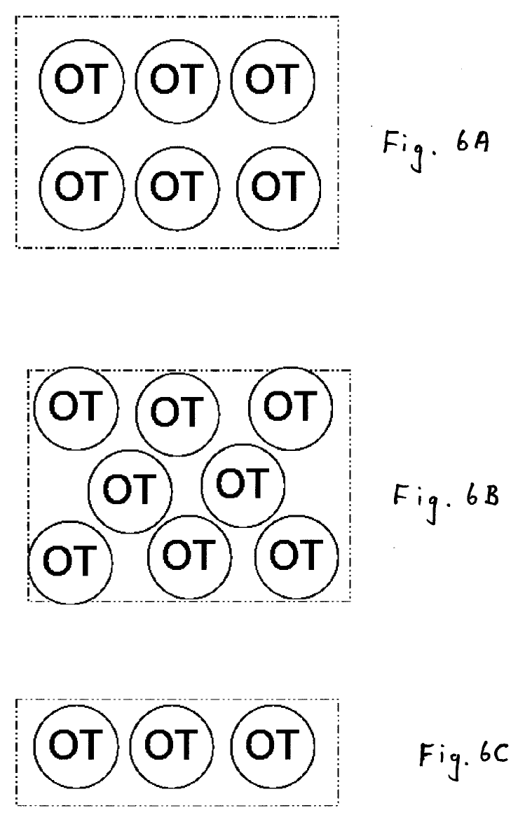

Reference is now made to FIGS. 6A to 6C, which schematically illustrate different alternative geometrical positioning of the optical transceivers of the present invention. The geometrical positioning of the receivers and transmitters in the spatial domain could be vector or matrix. FIG. 6A shows them arranged in a 2-dimensional matrix array, FIG. 6B in a 2-dimensional staggered matrix array, and FIG. 6C in a one-dimensional vector configuration.

The various preferred embodiments described hereinabove are operative to increase the transmission reliability of the bus signals, regardless of the source of degradation of transmission reliability. However, there are a number of specific environmental and physical effects that effect the propagation of the signal, resulting in signal fading and in cross talk, and leading to impaired bus performance. Further preferred embodiments of the present invention are presented in order to overcome these disadvantages. In particular, an algorithm is presented whose use enables the system to contend with some of these environmental and physical sources of interference.

Among the sources of such environmental and physical interference are the following:

(i) Non Uniform Heating Distribution

Thermal gradients are caused by the heat emitted by chips and electronic components during normal operation. Two such thermal gradient effects are the thermal bending of the board or mechanical structure, and turbulence. Turbulence results in random changes in the refractive index of the signal transmission path. This phenomenon is due to the temperature gradients between the chips, passive components, opto-electronic devices and the propagation medium. Simplification of the Maxwell equation for a turbulence channel, assuming that the field at any point in the medium can be written as the product of the free space field and the stochastic complex amplitude transmittance describing the field perturbation, has been described in the chapter entitled “Optical wireless communication” by the present inventor, in the “Encyclopedia of Optical Engineering”, edited by R. G. Driggers, published by Marcel Dekker, pp. 1866-1886, (2003).

The outcome of such turbulence is fading of the received signal and cross talk, leading to impaired link performance. Methods have been suggested for overcoming the effect of turbulence, such as in above mentioned U.S. Pat. No. 6,661,943, by enclosing the paths of the optical bus within ducts. However, this solution is cumbersome and inflexible.

(ii) Scattering by Particulates

In most practically used optical buses, the system is not contained in a vacuum, such that some molecules and particulates are suspended in the transmission medium. As a result, light propagating in the medium can collide with molecules and particulates. Such collisions cause absorption and scattering, which can be wavelength dependent. In the case of scattering, a photon transmitted from one transmitter element may reach the wrong detector element in the receiver. These interference effects reduce the system bit rate and increase the quantum bit error rate.

(iii) Bus Mechanical Impact and Vibration

Mechanical vibration and impact on a bus generates vibration in the line of sight beam from transmitter to receiver, and the communication system performance is degraded. The sources of such interference can be external or internal. When the bus subsystem is in a mobile device such as a laptop computer, or is in a computer system built into a car, airplane or ship, the impact of vibration will propagate from the motor or structure of the vehicle or vessel to the bus subsystem. Internal sources include the cooling fan, hard-disk and any other mechanical device attached to the Bus.

(iv) Misdirected Light

Due to the fact that the optical system is not ideal, part of the propagated light may be misdirected away from its intended direction, whether because of poor aiming accuracy of some component, or because of higher-than-planned beam divergence from some component in the transmission path. This light may be received by a neighboring receiver and cause interference to the channel intended for that neighboring receiver. Additionally, stray light from external sources can also interfere with the quality of the transmission.

(v) Non Linearity and Dispersion of the Propagation Medium

If the optical bus system is such that free space propagation is generated within a medium other than air or vacuum, such as in a clear plastic or within a silicon substrate, but not in a guided mode, the medium could cause the signals to undergo dispersion or distortion, resulting in degraded transmission.

Some or all of the above described mechanisms result in interference between neighbors links, caused by illumination of a neighboring receiver with optical signal from another link not intended for that receiver. The sources of unwanted illumination can be mechanical vibration, air turbulence, thermal bending or simply lack of optical precision in a long length bus, or any other reason. In order to mitigate the effects of such interference, according to another preferred embodiment of the present invention, there is proposed a method of using the information from all the receiver array elements and making the optimum information transmission decision in parallel. There are generally arrays of receivers and transmitters at each bus node, each with the required optics and electronics for making the adjustments based on the information transmission decision.

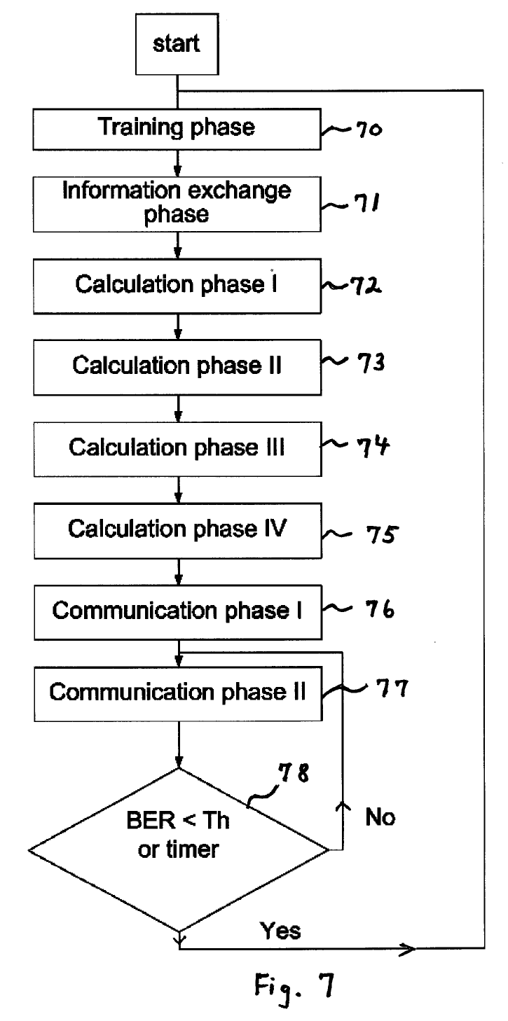

Reference is now made to FIG. 7, which is a flow diagram of a method, according to a further preferred embodiment of the present invention, utilizing a novel algorithm to improve the performance of the bus. The algorithm has a number of separate steps, and although the embodiment of FIG. 7 shows all of the steps being used sequentially, it is to be understood that the method can preferably utilize some or all of the steps, as required. The entire algorithm preferably includes the following steps:

(a) Training phase 70. The bus includes several nodes. Each node preferably includes an array of optical transmitters and an array of optical receivers. In order to measure the attenuation and time domain spread from all of the transmitters to all the receivers, a short pulse is transmitted from one transmitter and the signal received by all the receivers at all nodes is measured, both in magnitude and temporally relative to the time of transmission. This procedure is repeated sequentially for all the transmitters over all the nodes. The measurements provide (i) the levels of attenuation and the propagation spread of the desired signals in transit from the transmitters to the destination receivers, and (ii) the levels of interference arising from the signals received by receivers other than the intended destination receiver. The measurements are inserted as the elements of the transmission matrix. Each matrix element describes the attenuation between a specific transmitter at one node to a specific receiver at another node, such that a transmission function for the signal and interference can be determined for each channel. Moreover, the time spread characteristics of the received signals are stored in a 3-dimensional matrix, with the time delay as the third dimension.

(b) Information exchange phase, 71. The bus transceivers exchange information relating to the matrices. The information contained in all the matrixes is used in order to improve the transmission quality, as preferably determined by the Bit Error Rate (BER) of the transmission. Preferably, the parameters which are adjusted to improve the BER may include parameters related to the transmitters, such as the power, beam divergence, wave-length and beam polarization, or to the transmitter array parameters such as the division of the data vector signal between the transmitter array elements, as well as parameters related to the receivers, such as the sensitivity, gain, equalizer coefficients, field of view and polarization sensitivity, or to the receiver array parameters such as the division of the received vector signal between the receiver array elements.

The adaptation to optimize the BER could be done in the transmitter, the receiver, or in both of them. Referring to the matrix equation (1) below, the X vector represents the data transmitted, the received signal values are contained in the Y vector, and the transmission matrix with its hᵢⱼ elements represents the attenuation between each transmitter and each receiver. The received signal y₁ includes the attenuated desired signal transmitted as x₁, and in addition, the interference created in y₁ by the transmitted signal x₂, and a noise term [n].

$$[ \begin{matrix}{y}_{1} \\ {y}_{2}\end{matrix} ] = [ \begin{matrix}{h}_{11} & {h}_{12} \\ {h}_{21} & {h}_{22}\end{matrix} ] [ \begin{matrix}{x}_{1} \\ {x}_{2}\end{matrix} ] + [ \begin{matrix}{n}_{1} \\ {n}_{2}\end{matrix} ] \qquad ( 1 )$$

According to a first preferred method, the optimization process is represented by the orthogonalization of the transmission matrix as closely as possible, such that the received signals have maximum directly transmitted magnitude and minimum cross-term interference. This can be achieved by signal processing techniques, which can be achieved either by pre-coding performed in the transmitter or by reception shaping performed in the receiver, or by a combination of both. This signal processing step can be represented mathematically by multiplication of the transmission matrix by its inverse, such that the interference can be reduced and optimally eliminated, and the transmission maximized. This step is shown in the matrix equation (2) below.

$${[ \begin{matrix}{h}_{11} & {h}_{12} \\ {h}_{21} & {h}_{22}\end{matrix} ]}^{- 1} [ \begin{matrix}{y}_{1} \\ {y}_{2}\end{matrix} ] = {[ \begin{matrix}{h}_{11} & {h}_{12} \\ {h}_{21} & {h}_{22}\end{matrix} ]}^{- 1} [ \begin{matrix}{h}_{11} & {h}_{12} \\ {h}_{21} & {h}_{22}\end{matrix} ] [ \begin{matrix}{x}_{1} \\ {x}_{2}\end{matrix} ] + {[ \begin{matrix}{h}_{11} & {h}_{12} \\ {h}_{21} & {h}_{22}\end{matrix} ]}^{- 1} [ \begin{matrix}{n}_{1} \\ {n}_{2}\end{matrix} ] \qquad ( 2 )$$

In order to implement this concept in practice, a processing network is used, comprising multipliers and summation amplifiers. Each electronic input is multiplied by a different weighting factor and the results are summed. The output of this summation is the first channel output. This is repeated for all of the channels. This procedure can be implemented either in the electronic circuitry, or by sampling and software signal processing. Alternatively and preferably, this can be implemented optically by using an adaptive optical spatial filter in the optical domain, either at the optical output of the transmitters or at the optical input of the detectors. The weighting factors can be obtained in a number of ways. Use can be made of the elements obtained from the inversion of the transmission matrix, as described in equation (2) above. This transformation can be performed either in the transmitter or in the receiver.

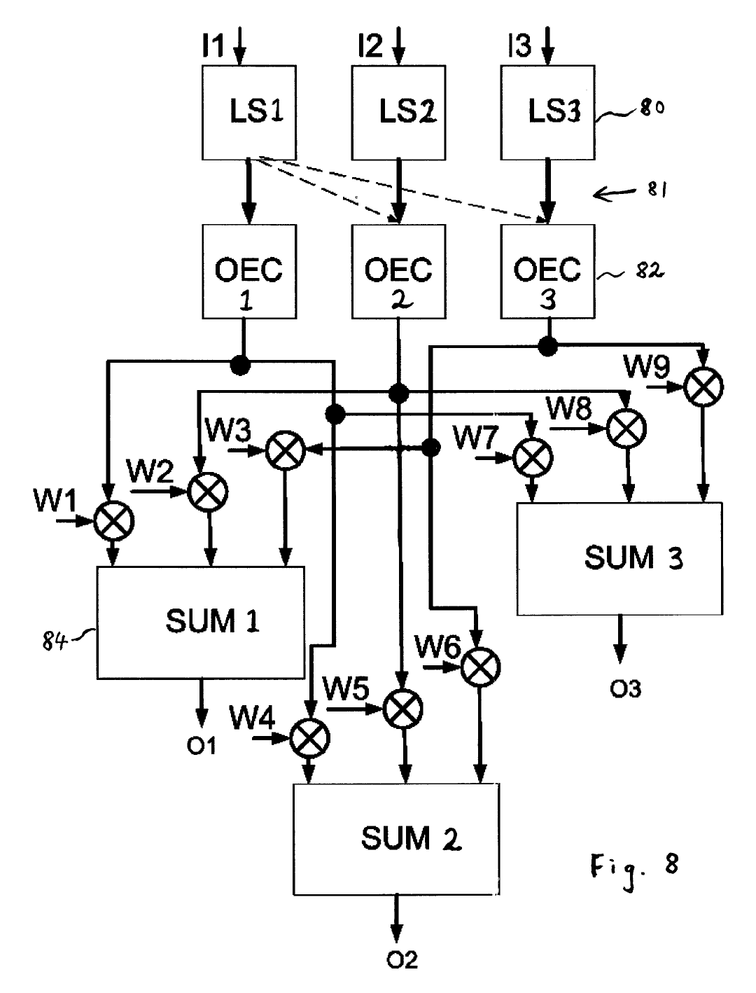

Reference is now made to FIG. 8, which illustrates schematically a block diagram of a system, according to a preferred embodiment of the present invention, in which this bus optimization procedure is performed electronically in the receivers, by the receiver shaping process. For simplicity, the preferred system is shown having a transmitter array with only three light sources (LS) 80, which are modulated with the incoming information streams labeled I1 to I3. The optical signals are then propagated down the free space bus 81 to the receivers. During this propagation process, part of the light is transmitted directly to its intended destination receiver, as indicated by the solid lines, and part is transmitted to neighboring receivers other than the intended destination receiver as interference signals as shown by the dashed lines (shown for simplicity only for the example of channel 1).

The opto-electronic converters (OEC) 82 at the receiver inputs, or the receiver photo-detectors, convert the light into electronic signals. Referring now to channel 1, the desired transmitted signal output from OEC1 multiplied by a weighting factor W1, is input to an electronic summation amplifier SUM1 84, and is summed with the cross-interference signals from the neighboring channels, each weighted by its specific weighting factor—the output from OEC2 multiplied by W2, and that from OEC3 by W3. The output O1 from this summer is the optimized channel 1 output. Similarly, the signals in channels 2 and 3 are weighted with their corresponding weighting factors, and summed to generate their respective optimized outputs. The weighting factors are obtained from the elements of the inversed matrix described in equation (2) above.

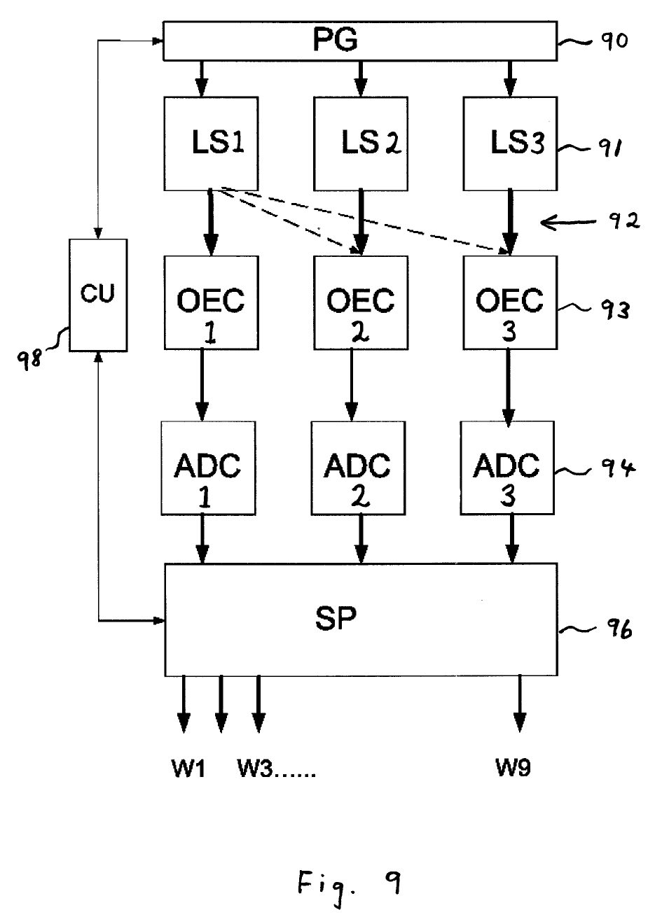

Reference is now made to FIG. 9 which illustrates schematically a block diagram showing how the weighting factors W1 to W9 of FIG. 8 can preferably be obtained during the training phase described in step 70 of the algorithm of FIG. 7. A pulse generator 90 is preferably used to output a sequence of pulses used to generate the train of single pulses of light emitted by the light sources 91 in order to determine the transmission characteristics of each of the channels of the bus 92. The individual pulsed transmissions are received by the opto-electronic converters 93, and are passed to analog-to-digital converters 94, to generate an equivalent digital representation for processing. The signal processor 96 uses these digital signals to generate the weighting factors W1 to W9, preferably by one of the calculation methods described above. A control unit 98 controls the timing of the training pulse output and associates the correct weighting factors with each pulse.

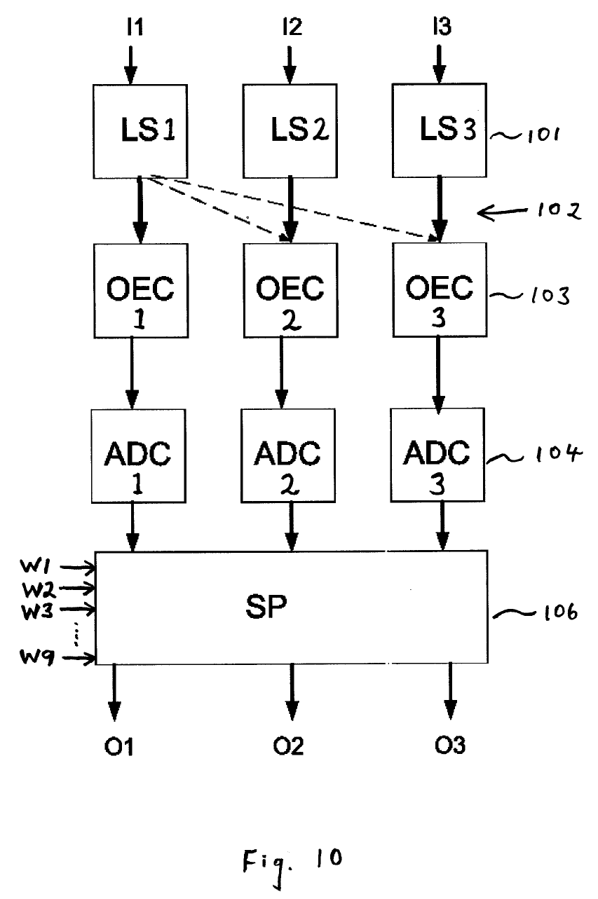

Reference is now made to FIG. 10, which illustrates schematically a block diagram of a system, according to another preferred embodiment of the present invention, similar to that shown in FIG. 8, but in which the optimization procedure is performed in the receivers by software manipulation of the signals in digital form, rather than the analog manipulation of FIG. 8. The optical signals emitted by the light sources 101 are transmitted down the optical free space bus 102, received and converted to analog signals in the opto-electornic converters 103, converted to digital form in the A/D converters 104, and then passed to the signal processor 106. Here each of the signals is weighted by its appropriate weighting factor, with the multiplication process and the summing being performed in software. The weighting factors can preferably be obtained by the training procedure shown n FIG. 10. A digital representation of each signal is output as O1 to O3, for immediate use, or the signals can be reconverted to analog form if required, by D/A converters.

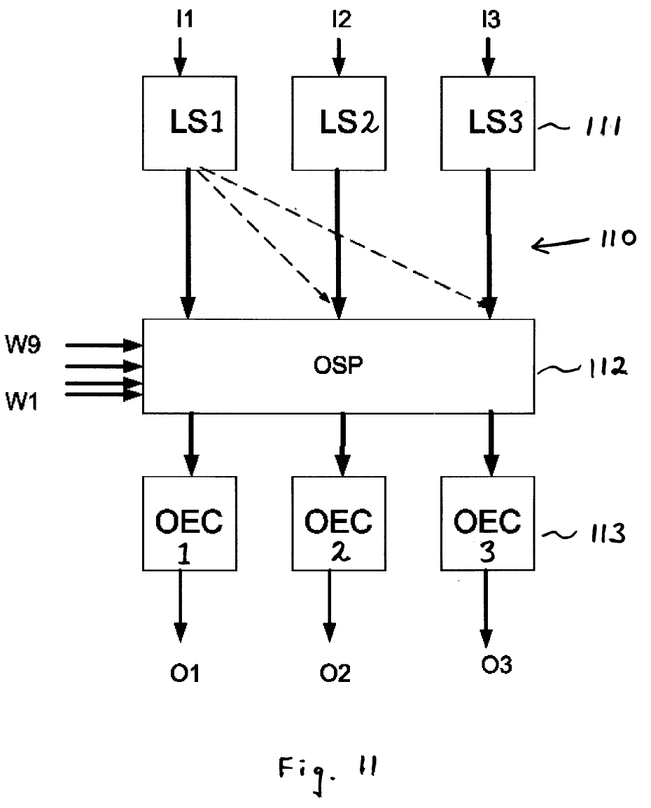

Reference is now made to FIG. 11, which illustrates schematically a block diagram of a system, according to a further preferred embodiment of the present invention, in which the bus optimization procedure is implemented optically by using an adaptive optical spatial filter in the optical domain, either at the optical output of the transmitters or at the optical input of the detectors. As previously, the light sources 111 transmit the information I1 to I3 as optical signals down the bus 110. In this embodiment, however, the signal processing required in order to weight and add the signal components from the three channels is performed by means of optical manipulation using a dynamic spatial optical filter element 112, operative as an analog optical signal processor. The optical properties of the spatial filter are adjusted according to the values of the weighting factors W1 to W9 which are input electronically. The filter can be implemented by any electro-optical technology capable of performing those of the processes of dividing, redirecting, switching modulating and attenuating the optical beams, as required to perform the analog optical signal processing steps for bus optimization. The electro-optical technology should be fast enough to be useable at the communication speeds required in optical buses. After optical processing, the bus signals are detected at the receiver inputs by the opto-electrical converters 113, and the electronic output signals O1 to O3, being already optimized in the optical domain, can be used directly without the need for further processing.

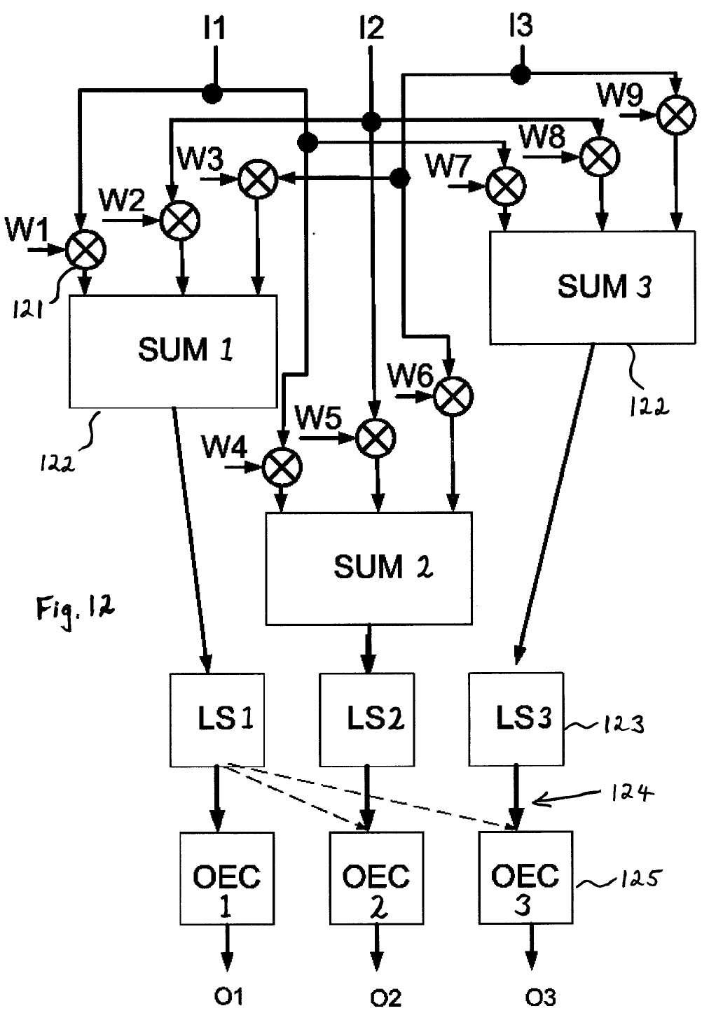

Reference is now made to FIG. 12, which illustrates schematically a block diagram of a system, according to another preferred embodiment of the present invention, in which the bus optimization procedure is performed electronically in the transmitters, by means of an electronic pre-coding process. This embodiment uses a similar signal processing procedure to that shown in FIG. 8, except that the processing is applied in the transmitters by electronically modulating the information streams I1 to I3, such that the signals transmitted by the light sources 123 are already pre-coded according to the optimization data. The weighting factors W1 to W9 are used to electronically multiply 121 components of the input signals I1 to I3, and the weighted signals are summed in the summing amplifiers 122 before being sent to the light sources 123 for transmission down the bus 124. After propagation, simple linear detection can then be performed in the receivers 125, to obtain the optimized output signals O1 to O3. As in the previous bus embodiments shown, the weighting factors W1 to W9 of FIG. 12 can preferably be obtained during the training phase described in step 70 of the algorithm of FIG. 7.

Alternatively and preferably, the optimization procedure can be performed in the transmitters by software manipulation of the signals in digital form, rather than the analog manipulation of FIG. 12, in an analogous way to the software processing performed in the receivers as shown in FIG. 10.

According to other preferred embodiments, a combination system can be used, in which signal processing is performed both in the transmitters on the transmitted signals, and in the receivers on the received signals after propagation. A combination of FIGS. 8 and 12 is then preferably used.

(c) Calculation phase I, 72. Returning now to the algorithm of FIG. 7, according to another preferred embodiment of the present invention, instead of matrix inversion manipulation, singular value decomposition (SVD) can be used in order to determine the adaptation of the transmission parameters to optimize the BER, and the signal processing is then divided between the transmitter array and receiver array. In linear algebra, singular value decomposition (SVD) is an important factorization of a rectangular real matrix with several applications in signal processing and statistics. In some respect this matrix decomposition is similar to the diagonalization of symmetric matrices using a basis of eigenvectors given by the spectral theorem. The parallel decomposition of the transmission channel is obtained by defining a transformation on the channel output by means of transmitter preceding and on the electronic channel input by receiver shaping. The preceding and shaping are done using linear transformation on the input and output respectively. This procedure transforms the multiple input, multiple output (MIMO) channel into parallel single input single output (SISO). In this case the detection procedure is done using a standard maximum likelihood detection algorithm such as is known in communication theory. Alternatively and preferably, use may be made of this information in the algorithm for optics systems, as described in the article entitled “Analysis of the Performance of a Wireless Optical MIMO Communication System,” by D. Bushuev and S. Amon, to be published in Journal of the Optical Society of America, A (July 2006), or a similar algorithm developed for RF communication, such as that described in U.S. Pat. No. 6,317,466, for “Wireless communications system having a space-time architecture employing multi-element antennas at both the transmitter and receiver” to G. J. Foschini et al.

(d) Calculation phase II 73. Each transmitter calculates the minimum power required for a given bit error rate (BER) for each bus node.

(e) Calculation phase III, 74. A calculation is made for each receiver of the parameters of the required time equalization circuits or elements in order to overcome dispersion and multi-path propagation effects for each bus node. This can be achieved by use of any of the methods known in the art

(f) Calculation phase IV 75. Unlike RF links, where shot noise is generally small, in optical free space communication, shot noise is often the dominant noise source, exceeding the dark current noise, thermal noise and background noise. Shot noise is linearly dependent on the signal itself, and information about the noise is estimated for each transmitter-receiver combination on the bus. In such a case, we can estimate the noise level from the measured matrix and the received signals. The received signals are bound between known boundaries, for example 0 and 1. To estimate the power, all of the matrix's elements that relate to a specific detector are multiplied by the received signals respectively and the signal shot noise is calculated. This information is transferred to the decision-making device elsewhere in the system. Alternatively and preferably, use can be made of the V-BLAST algorithm as described in the article “Detection algorithm and initial laboratory results using V-BLAST space-time communication architecture” by G. D. Golden et al., published in Electronics Letters, Vol. 35, No. 1, Jan. 7, 1999, and in the above mentioned U.S. Pat. No. 6,317,466.

(g) Communication Phase I, 76. For systems in which different functional elements can communicate with each other directly, without the need to involve the CPU, an optional and different procedure may preferably be followed. For each bus node that commences transmission, the transmitter parameters (precoding and power) are tuned to the desired destination, and transmission preferably opens with an identifying announcement, such as “CPU to Memory M4” or “CPU transmitting” but without specifying a destination. This procedure makes it possible for the receiving unit to tune its parameters (by shaping and equalization). Alternatively and preferably, the transmitter can be optimized in a similar manner. This phase can preferably be executed at a lower data rate than the clock rate.

(h) Communication phase II, 77. The transmitter transmits the information to the destination and the receiver preferably uses a standard algorithm for maximum likelihood detection of symbol sequence to detect the information.

(i) Conclusion phase, 78. The BER is compared with a predetermined optimum threshold level. If the algorithm has not reduced the BER below that level, the iterative process is returned without any time delay to an earlier optimization step, the step being preferably chosen according to the closeness of the BER to the threshold level. In the example shown in FIG. 7, control is returned to step 77, but it is to be understood that control can equally be returned to any of the previous steps of the algorithm. Alternatively and preferably, the control can be returned at regular preset time intervals to an earlier step.

If the BER is found to be below the predetermined optimum threshold level, then transmission is continued undisturbed, until the time interval at which a new training and optimization procedure is to be performed, by returning to step 70 of the procedures of the method. This time interval, as previously mentioned, is preferably dependent on the environmental conditions in which the bus system is located, such that poor conditions, causing rapid deterioration of the BER, engender a more frequent optimization procedure to be initiated.

(i) Steps (a) to (g) are repeated frequently, at a rate depending on the rate at which the environment changes.

It is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

I claim:

1. A method of improving the transmission quality of a free-space optical bus system comprising the steps of:
providing an optical bus having a plurality of transmitters and receivers connected by optical paths;
transmitting a signal onto said bus from one of said transmitters;
measuring said signal received by at least some of said receivers;
repeating said steps of transmitting and measuring for additional ones of said transmitters;
utilizing said measured signals to generate a transmission quality function for said bus; and
optimizing said transmission quality function by adjusting at least one characteristic associated with transmission along at least one of said paths.

2. The method of claim 1 and wherein said at least one characteristic is a characteristic of at least one of said transmitters.

3. The method of claim 2 and wherein said transmitter characteristic comprises at least one of emitted power, beam divergence, emitted wavelength, beam polarization, antenna gain and antenna polar diagram.

4. The method of claim 1 and wherein said at least one characteristic is a characteristic of at least one of said receivers.

5. The method of claim 4 and wherein said receiver characteristic comprises at least one of power sensitivity, gain, equalizer coefficients, field of view, polarization sensitivity, antenna gain and antenna polar diagram.

6. The method according to claim 1 and wherein said transmission quality of said bus is ascertained by measuring the transmission bit error rate along at least some of said optical paths.

7. The method according to claim 1 and wherein said transmission quality improvement counteracts the effects of at least one of mechanical and thermal environmental effects on said bus.

8. The method according to claim 1 and wherein said transmission quality function is generated by utilizing each of said measured signals as elements in a two dimensional transmission matrix.

9. The method according to claim 8 and wherein said matrix maps desired transmission between transmitters and their intended destination receivers, and transmission interference between transmitters and receivers other than said intended destination receivers.

10. The method according to claim 9 and wherein signals relating to desired transmission between transmitters and their intended destination receivers are used as diagonal elements of said matrix, and signals relating to transmission interference between transmitters and receivers other than said intended destination receivers are used as off-diagonal elements of said transmission matrix.

11. The method according to claim 8 and wherein said transmission quality factor is optimized by signal processing at least one of the transmitted signal or the received measured signal, said signal processing using elements derived from the inversion of said transmission matrix.

12. The method according to claim 8 and wherein said transmission quality factor is optimized by signal processing of the transmitted signal and the received measured signal, using elements derived from single value decomposition of said matrix.

13. The method according to claim 8 and further comprising the steps of:
measuring the time of arrival of said transmitted signals at at least some of said receivers, and
storing said times of arrivals in a third array of said two dimensional matrix, such that the time domain equalization of said receivers can be performed.

14. The method according to claim 1 and wherein said step of measuring said signal received by at least some of said receivers is performed for all of said receivers, and said step of repeating said steps of transmitting and measuring is performed for all of said transmitters.

15. A free space optical bus system for transferring information, said bus system comprising:
a plurality of light transmitters, each transmitting signals containing part of said information;
a plurality of receivers for receiving signals over free space from said transmitters, at least some of said received signals comprising a linear combination of said transmitted signals; and
a plurality of detection processors, one for each receiver, each receiving at least some of said received signals and applying weighting factors thereto, summing said weighted received signals and outputting said summations,
wherein said weighting factors are derived by transmitting a signal onto said bus sequentially from each of said transmitters and measuring the received signals at all of said receivers from each sequentially transmitted signal; using said measured signals to generate a transmission matrix for said plurality of transmitters and receivers; and using the elements of said transmission matrix to generate said weighting factors.

16. A free space optical bus system according to claim 15 wherein signals relating to desired transmission between transmitters and their intended destination receivers are used as diagonal elements of said matrix, and signals relating to transmission interference between transmitters and receivers other than their intended destination receivers are used as off-diagonal elements of said matrix.

17. A free space optical bus system according to claim 15 wherein said weighting factors are generated from elements obtained by calculating the inverse of said transmission matrix.

18. A free space optical bus system according to claim 15 and further comprising a plurality of source and destination nodes connected by free space optical links, at least some of said links having different propagation properties, such that at least some of said links are associated with different transmission matrices, and wherein said weighting factors are adjusted according to knowledge about said link used between source and destination nodes.

19. A free space optical bus system according to claim 18 and wherein a protocol is used in said system to declare the addresses to be linked, such that said weighting factors can be adjusted at any one of the destination and source of the requested link, according to the content of said protocol.

20. A free space optical bus system according to claim 18 and wherein at least one of said source and said destination nodes is preprogrammed with information about its links with at least one other node in said system.

21. A free space optical bus system according to claim 15 and further comprising a plurality of information signal processors, each processor receiving at least part of said information, at least one of said processors comprising electronic multipliers applying a second set of weighting factors to said received information, and an electronic summer for summing said received information weighted with said second set of weighting factors, and for outputting said summed weighted information to said light transmitters.

22. A free space optical bus system according to claim 21 and wherein said weighting factors and said second set of weighting factors are generated from elements obtained by singular value decomposition performed on said transmission matrix.

23. A free space optical bus system for transferring information contained in a number of channels, said bus comprising:
a plurality of signal processors, each processor receiving said information in at least some of said channels, at least one of said processors comprising electronic multipliers applying predetermined weighting factors to said received information, and an electronic summer for summing said weighted received information and for outputting said summed weighted information;
a plurality of light sources receiving said outputs from said signal processors, and transmitting said outputs as optical signals onto said bus; and
a plurality of receivers for receiving optical signals from said transmitters over said free space bus, and for outputting said information;
wherein said weighting factors are derived by transmitting a signal onto said bus sequentially from each of said transmitters and measuring the received signals at all of said receivers from each sequentially transmitted signal; using said measured signals to generate a transmission matrix for said plurality of transmitters and receivers; and using the elements of said transmission matrix to generate said weighting factors.

24. A free space optical bus system according to claim 23 wherein signals relating to desired transmission between transmitters and their intended destination receivers are used as diagonal elements of said matrix, and signals relating to transmission interference between transmitters and receivers other than their intended destination receivers are used as off-diagonal elements of said matrix.

25. A free space optical bus system according to claim 23 wherein said weighting factors are generated from elements obtained by calculating the inverse of said transmission matrix.

26. A free space optical bus system according to claim 23 and comprising a plurality of source and destination nodes connected by free space optical links, at least some of said links having different propagation properties, such that at least some of said links are associated with different transmission matrices, and wherein said weighting factors are adjusted according to knowledge about said link used between source and destination nodes.

27. A free space optical bus system according to claim 26 and wherein a protocol is used in said system to declare the addresses to be linked, such that said weighting factors can be adjusted at any one of the destination and source of the requested link, according to the content of said protocol.

28. A free space optical bus system according to claim 26 and wherein at least one of said source and said destination nodes is preprogrammed with information about its links with at least one other node in said system.

29. A free space optical bus system according to claim 23 and also comprising a plurality of detection processors, one for each receiver, each receiving at least some of said received signals and applying a second set of weighting factors thereto, summing said received signals weighted with said second set of weighting factors, and outputting said summations.

30. A free space optical bus system according to claim 29 and wherein said weighting factors and said second set of weighting factors are generated from elements obtained by singular value decomposition performed on said transmission matrix.

31. A free space optical bus system comprising a plurality of links for transferring information between a plurality of nodes, wherein at least two of said links transmit information at different wavelengths over essentially the same optical path.

32. A free space optical bus system according to claim 31 and wherein each of said links has a predetermined functionality, such that different functionalities can be separated by the wavelength of an optical signal used to transmit those functionalities.

33. A free space optical bus system according to claim 31 and wherein each of said links has a predetermined functionality, at least one of said functionalities comprising at least two different parts, and wherein each of said different parts is transmitted using a different wavelength, such that part selection may be made by selection of transmission wavelength.

34. A free space optical bus system according to claim 33 and wherein said different parts are any one of different memory blocks and different input/output groups.

35. A free space optical bus system according to claim 33 and wherein said wavelength selection enables chip select operations to be performed in the optical domain.

36. A free space optical bus system according to claim 31 and wherein selection of said different wavelengths is performed using a dispersive optical element.

37. A free space optical bus system comprising a plurality of links for transferring information between a plurality of nodes, wherein at least two of said links transmit information having a different code over essentially the same optical path.

38. A free space optical bus system for transferring optical signals between transmitters and receivers located at different nodes on said bus system, said bus system comprising sets of polarization discriminating elements located at said nodes and impressing a polarization characteristic on a signal traversing them, such that a signal leaving said bus can be spatially separated from a signal transmitted onto said bus by means of said polarization characteristic.

39. A free space optical bus system according to claim 38 and wherein said signal leaving said bus is directed to a receiver by a set of polarization discriminating elements associated with said receiver.

40. A free space optical bus system according to claim 38 and wherein said sets of polarization discriminating elements comprise at least one of a polarized beam splitter and a wave plate.

41. A free space optical bus system according to claim 39 and wherein said wave plate is a quarter wave plate, and said polarization characteristic is circular polarization.

42. A free space optical bus system according to claim 39 and wherein said wave plate is a half wave plate, and said polarization characteristic is a linear polarization.

43. A free space optical bus system for transferring a plurality of optical signals serving a number of functionalities between transmitters and receivers located at nodes of said system, wherein said system comprises a number of light sources less than said number of said functionalities served by said bus.

44. A free space optical bus system according to claim 43 and also comprising an optical modulator at at least one of said nodes, such that at least one of said optical signals is generated by modulating an optical beam with information to be transmitted down said bus.

45. A free space optical bus system according to claim 43 and wherein said number of light sources is a single light source.

46. A free space optical bus system for transmitting optical signals between transmitters and receivers located at nodes of said system, and also comprising at least one device for spatially directing said optical signals such that the line of sight between at least one transmitter and one receiver may be adjusted to optimize transmission of said optical signals.

47. A free space optical bus system according to claim 46 and wherein said device for spatially directing said optical signals comprises any one of an acquisition device, a tracking device and a pointing device.
